(19) United States
(12) Patent Application Publication
(10) Pub. No.: US 2025/0245218 A1
(43) Pub. Date: Jul. 31, 2025

(54) METHODS AND APPARATUS FOR A RETRIEVAL AUGMENTED GENERATIVE (RAG) ARTIFICIAL INTELLIGENCE (AI) SYSTEM

(71) Applicant: FEDDATA HOLDINGS, LLC, Annapolis Junction, MD (US)

(72) Inventor: Gianluca LONGONI, Bethesda, MD (US)

(21) Appl. No.: 19/042,824

(22) Filed: Jan. 31, 2025

Related U.S. Application Data
(60) Provisional application No. 63/627,348, filed on Jan. 31, 2024.
(60) Provisional application No. 63/560,266, filed on Mar. 1, 2024.
(60) Provisional application No. 63/566,578, filed on Mar. 18, 2024.

(51) Int. Cl. G06F 16/245; G06F 16/22; G06F 16/2457; G06F 16/248

(52) U.S. Cl. CPC G06F 16/245; G06F 16/2255; G06F 16/24578; G06F 16/248

(57) ABSTRACT

A non-transitory, processor-readable medium storing instructions that when executed by a processor, cause the processor to receive data artifacts, encode the artifacts to a standard data type, and compute, for each artifact, a hash function. The hash functions and encoded documents are stored in a first database. The processor is caused to tokenize the encoded artifacts, to produce tokens associated with natural-language identifiers extracted from the encoded artifacts. The processor is caused to transform, using an embedding model, the tokens to produce vectors that are stored in a second database and classified based on categories. The second database is configured to be queried to perform a semantic search in response to receiving a request from a user operating a user compute device. The processor is caused to retrieve, from the semantic search, a subset of vectors from the second database to be displayed on the user compute device.

### CROSS-REFERENCE TO RELATED APPLICATION(S)

This application claims priority to U.S. Provisional Patent Application No. 63/627,348, filed on Jan. 31, 2024, to U.S. Provisional Patent Application No. 63/560,266, filed on Mar. 1, 2024, and to U.S. Provisional Patent Application No. 63/566,578, filed on Mar. 18, 2024, the disclosures of which are incorporated herein by reference in their entirety.

### FIELD

The present disclosure generally relates to the field of generative artificial intelligence. In particular, the present disclosure is related to methods and apparatus for a retrieval augmented generative (RAG) artificial intelligence (AI) system.

### BACKGROUND OF THE INVENTION

Some generative artificial intelligence (AI) systems use techniques such as deep neural networks to generate novel outputs based on patterns learned from large datasets. The amount of data generated by human activities nowadays can be immense, with petabytes of data generated on a daily basis, and the ability of users of current generative AI systems to extract valuable insights and actionable information from massive data sets is becoming very challenging, particularly in situations where multiple concurrent users must operate in an enterprise setting on very diverse datasets. Therefore, the development of an AI system that is capable of searching and analyzing large datasets to accurately respond to natural language user queries, while maintaining performance, minimizing the return of irrelevant data, and supporting transparency with underlying sourcing references, is needed. Data exploration and information retrieval on very large sets can be improved by using generative AI natural language processing algorithms coupled with powerful semantic search algorithms. In addition, these systems can be architected to maintain peak performance for large-scale deployments in enterprise environments.

### SUMMARY

In one or more embodiments, a non-transitory, processor-readable medium storing instructions that when executed by a processor, can cause the processor to receive a plurality of data artifacts, including documents or other type of data such as audio files, having a plurality of data types. The processor can be further caused to encode the plurality of data artifacts to a standard data type. The processor can be further caused to compute, for each data artifact from the plurality of data artifacts, a hash function from a plurality of hash functions. The plurality of hash functions and the plurality of encoded data artifacts can be stored in a first database. The processor can be further caused to tokenize the plurality of encoded data artifacts, to produce a plurality of tokens from the plurality of encoded data artifacts. The plurality of tokens can be associated with natural-language identifiers extracted from the plurality of encoded data artifacts. The processor can be further caused to transform, using an embedding model, the plurality of tokens to produce a plurality of vectors. The plurality of vectors can be stored in a second database and classified based on a plurality of categories. The second database can be configured to query a performance of a semantic search in response to receiving a request from a user operating a user compute device. The processor can be further caused to retrieve, from the semantic search, a subset of vectors from the plurality of vectors in the second database to be displayed on the user compute device.

In one or more embodiments, an apparatus comprises a processor and a memory operatively coupled to the processor. The memory can store instructions to cause the processor to receive, from a user compute device, an input including a request and a set of parameters for the request. The instructions can further cause the processor to send a signal to at least one node from a plurality of nodes based on the request. Each node from the plurality of nodes can store a copy of a large language model. The signal can include instructions to execute the copy of the large language model from the at least one node. The instructions can further cause the processor to query, via the copy of the large language model from the at least one node, a database storing a plurality of vectors with respect to the set of parameters and the request, to retrieve a subset of vectors from the plurality of vectors in the database. The instructions can further cause the processor to generate a relevance score for a data source associated with the subset of vectors. The instructions can further cause the processor to filter the subset of vectors based on the set of parameters to retrieve a filtered subset of vectors. The instructions can further cause the processor to compile the filtered subset of vectors and the request to generate a prompt to be passed to the large language model for processing and to be displayed on the user compute device.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1 is a block diagram of a system for retrieval augmented generative AI, according to some embodiments.

FIG. 2 is an example diagram of a process for data ingestion and tokenization for a retrieval augmented generative AI system, according to some embodiments.

FIG. 3 is an example diagram of a process for data ingestion and AI query, according to some embodiments.

FIG. 4 is an illustrative diagram of a system for deployment of a compute cluster for retrieval augmented generative AI, according to some embodiments.

FIG. 5 is an illustrative diagram of a system for reverse proxying in retrieval augmented generative AI, according to some embodiments.

FIGS. 6-8 are example screenshots of a user interface for a retrieval augmented generative AI system, according to some embodiments.

FIG. 9 is a flow diagram of a method for inferencing a large language model for a retrieval augmented generative AI system, according to some embodiments.

FIG. 10 is a flow diagram of a method for executing one or more large language models for a retrieval augmented generative AI system, according to some embodiments.

FIG. 11 is an example screenshot illustrating a return of a query from a request by a user including an image of a source document associated with the return, according to some embodiments.

### DETAILED DESCRIPTION OF THE INVENTION

In some cases, generative artificial intelligence (AI) can refer to a branch of AI that can generate new and original content, such as images, videos, music, or text. In some cases, state-of-the-art generative AI methods can be based on a generative pre-trained transformer (GPT) model, which is the foundation for large language models (LLMs) today. LLMs are trained on massive amounts of textual data, and besides being able to recognize patterns in existing data, they can use those patterns to create new textual content, translate languages, and even answer questions using natural language. Generative AI has the potential to revolutionize many industries, such as defense, intelligence, medical, financial, sports, incident response, education, and many others, by enabling the creation of new and innovative content.

In some embodiments, the AI system described herein can be a proprietary retrieval-augmented generation (RAG), that can combine an information retrieval system with a generative AI natural language processing algorithm. In some implementations, the RAG AI system described herein can efficiently explore and extract valuable knowledge from very large data sets. A fast semantic algorithm can be used with an LLM to enable concurrent servings of hundreds of users per compute node.

### RAG AI

A RAG is a software application that combines a powerful semantic search engine and techniques, with an LLM to explore and interrogate a dataset using natural language. LLMs represent the new frontier of generative AI and they consist of very dense deep neural networks, based on the transformer model, capable of learning and understanding natural language. LLMs have been used for a variety of tasks, including text summarization, sentiment analysis, data analysis, language translation, and even as code generators for a variety of programming languages. The RAG AI system disclosed herein can include an LLM with a vector database for data storage. An embedded semantic search algorithm can accept a query from the user in natural language and searches for relevant data artifacts (e.g., documents, audio files, etc.) in the vector database. In the search algorithm, the concept of relevance score can be implemented to filter out irrelevant data during searches. The search results, referred to as context, are then processed by the LLM together with the user's query; when processing is complete the system returns an accurate answer that can be easily consumed by the user, together with the reference data sources that were used to produce the result. The combination of a relevance score algorithm and the availability of reference source data artifacts can make the RAG AI system described herein very robust, predictable, and accurate. In addition, the RAG AI system described herein can include a sophisticated web server architecture to serve the RAG to a large number of users with minimal impact on the system's performance.

Unlike other AI techniques that focus on recognizing patterns in existing data, generative AI models can create new patterns and structures, allowing them to generate novel and creative content. Generative AI can answer a long-standing problem in the digital era which deals with “information overload.” To this effect, the most important aspect in generative AI is the capability of analyzing, interpreting, and reasoning on massive amounts of data, almost reaching the compendium of human knowledge within a time scale meaningful to human activities. Aspects of the present disclosure can be or include a RAG AI system which includes a localized-on premises AI expert system that receives multiple queries (or requests) from users and generates, using an LLM, answers to the queries. Queries can also include “problem solving activities,” where the AI is prompted to provide one or more solutions, or alternatives to a problem. At a high level, the system works as follows. (1) User enters a query on a specific topic that is contained in the RAG dataset, (2) the RAG performs a semantic search within its knowledge base using the user's query and selects the most relevant data sources, (3) the LLM is prompted to answer the query or solve the problem by utilizing the context provided from the semantic search as well as conversational memory, if available, from past interactions with the user, and (4) a response is returned to the user, including reference sources utilized by the AI to solve the problem or generate the answer.

### Semantic Search

The RAG AI system can be implemented with a semantic search algorithm that is based on a nearest-neighbor search over a vector space, representing the dataset. Within this context the RAG can employ a “few shots learning” technique to generalize its knowledge to new data. For instance, data files can be parsed and text can be extracted and divided into chunks with overlap (e.g., a chunk size of 2000-tokens with a 200-tokens overlap). The chunked text can then be embedded or encoded into a 1-D vector space with a fixed dimension of 768 elements, using an appropriate vocabulary that is part of the embedding model. For an embedding model, performance is based on the similarity score obtained when performing a semantic search, the higher the score, the closer the search result is to the original query. The RAG AI system can enable or allow for the capability to “fine tune” the embedding model in order to specialize it in answering questions on a specific topic, for example aerospace engineering, federal government acquisitions, military tactics, tradecraft, tactics, and procedures.

### AI Ingest Engine

The RAG AI system can include an ingest engine since a dataset needs to be acquired, processed, and transformed into vector embeddings which are stored in a vector database. The process from a user's standpoint is very simple, since the user can drag and drop one or multiple data artifacts into a GUI exposed via a web server. The main features of the AI ingest engine can include an open-source vector store database and another database used to store a variety of information such as user credentials and data artifacts metadata. In some implementations, every data source (file) ingested by the engine can be hashed using a hashing algorithm to ensure traceability of the information. The ingest engine can support multiple and different types of text data sources. The ingest engine can also enable automatic parsing of the data source, as well as text chunking and embedding. The ingest engine can also support different collections of data sources with a role-based access control (RBAC) system to control user's access to specific collections.

### AI Query Interface

The RAG AI system can include an AI query interface that a user can interact with on a user compute device operated by the user. The AI query interface can be the main landing page for the user to interrogate the data sources via an LLM that is used to produce answers to queries from the user. In some implementations, features of the AI query engine can include an on-premises LLM that can be locally forked on servers without a need to access external entities, chatbot-like design to improve user experience in interacting with the AI, capability to use fine-tuned embedding models for semantic search, retrieval from data sources using the semantic search algorithm with pictures of the retrieved information from the AI, capability to work on different collections similarly to the AI ingest engine, and/or the like.

In some cases, AI-explainability can be achieved by providing the user with images of data artifacts being retrieved. This aspect can be important especially in highly regulated industries where the data source needs to be clearly identified to corroborate the answer from the AI. The LLM can be programmed “prompted,” and instructed to act only on the data sources and to avoid answering questions where no context can be found, to significantly reduce “hallucinations” such that the AI does not “make up answers.” Note that fine-tuning of embedding models can also contribute in reducing AI “hallucinations”. In some cases, the RAG AI system can include a chat memory component, via prompt engineering. For instance, the LLM can be prompted with a system prompt (where guard-railing can be implemented), the query from the user, the context from the semantic search, and the conversational history. By using this approach, a certain level of “conversational memory” can be introduced into the system to allow for a more natural conversation and human-machine interaction.

### Capabilities Highlight

The RAG AI system can be customized per user input and can be trained by the user via the few-shots learning technique. For instance, the user can provide selective data (e.g., digital documents) such that the RAG AI system can become an instant expert on the specific data provided. The RAG AI system can be implemented via the AI query interface that enables chat-friendly interface, speech-to-text recognition, text-to-speech recognition, and/or the like. For instance, a user operating a compute device can “drag-and-drop” documents to be ingested by the RAG AI system for training. Data can be processed on an air-gapped localized server for maximum security. The AI query interface of the RAG AI system can also include easy-to-use chat function for natural interaction with user data. The RAG AI system can also be scalable via additional nodes onto the compute device of the user in which each node can run a copy of an LLM (in parallel) to provide quicker responses back to the users, especially when the number of users is large. The RAG AI system can be fine-tuned based on specific use cases to enhance response accuracy. The RAG AI system can be implemented in a AI data management infrastructure that can manage and catalogue large volumes of data. The AI data management can enable separate data collections (e.g., data organized into different topics, collections, categories, etc.) with ad-hoc user access policies. The RAG AI system can also ingest data of different types and formats (e.g., PDF, Microsoft Word, PowerPoint, Excel, raw text, HTML web content, emails etc.), and additional data formats can be easily added if needed. The RAG AI system can also filter data before providing answers to the user to avoid hallucinations, e.g., data that is not pertinent to the user's query. The RAG AI can display only selected to data artifacts to the user; however, the AI can access every data artifact to generate an answer. This feature is of particular importance in situations where the user is authorized to query the AI, but is not authorized to see the source data artifacts.

In some implementations, the RAG AI system can implement RAG to efficiently explore large collections of data artifacts and to extract, quickly and effectively, answers to complex questions using natural language. The RAG AI system can include a fast semantic search algorithm that is coupled with an LLM to provide fast and accurate answers to complex queries using natural language. In some implementations, the RAG AI system can include features such as multiple LLMs for multi-user environments using scalable parallel computing architectures. In some cases, the RAG AI system can incorporate an inferencing engine using multi-node/multi-GPU acceleration for fast query response time and for supporting enterprise deployment. The AI query interface or a graphical user interface (GUI) can enable users to customize the GUI. The RAG AI system can be configured to retrieve data that can be augmented via access to certain reference sources and document images for effective data exploration. The RAG AI system can also filter data based on a relevance score calculated from results retrieved from semantic searches in response to queries. In some cases, a user can set a parameter for a relevance score such that the RAG AI system can only use results that reach or exceed the predetermined relevance score. The RAG AI system can be implemented with “guard railings” to set boundaries for its behavior. Aspects of the present disclosure can include an architecture and/or environment that includes the RAG AI system and databases to store embeddings, encodings, and/or vector representations of information from ingested data to accurately transform and store data for AI consumption. The RAG AI system can also be finetuned based on specific use cases to enhance response accuracy.

In some instances, enterprise-level leading edge RAG AI designed for multi-user environments can be scaled to thousands of users. The RAG AI system described herein can allow for a customer to have total control over server hardware, data content and configuration, and security, with no required access to third-party resources (e.g., LLM providers). The RAG AI system can also be hosted on multi-node/multi-GPU architectures to serve hundreds of users concurrently via a graphics processing unit (GPU) accelerated AI inferencing. The RAG AI system can also support proven LLMs with the capability of adding customized LLMs based on customer needs. Data retrieval can also be augmented with access to reference sources and document images to provide an additional layer of confidence in AI responses. Reference data used by the AI in generating the answer can be filtered using a relevance score calculated from the semantic search engine. Prompt engineering and guard-railing can instruct the AI to generate accurate answers on the specific context. The RAG AI system can also include embedding models and vector store databases to accurately transform and store data for AI consumption. The models can be finetuned based on specific use cases to enhance response accuracy. The RAG AI system can include a data management infrastructure to manage and catalogue large volumes of data. The RAG AI system can also be compatible to work on separate data collections with ad-hoc user access policies while supporting a variety of data formats (e.g., PDF, Microsoft, raw text, web scraping, etc.).

In some cases, the RAG AI system can support thousands of concurrent uses with latencies under 10 seconds for large context queries (average of 1,000 tokens). In some cases, ingest time for documents can be 170 pages per minute. In some embodiments, deployment of the RAG AI system can be scaled to various sizes. For example, at a small scale, up to 100 users for one node. For medium enterprises, up to 500 users for two to four nodes. For large data centers, multipole nodes can be used for users exceeding one thousand.

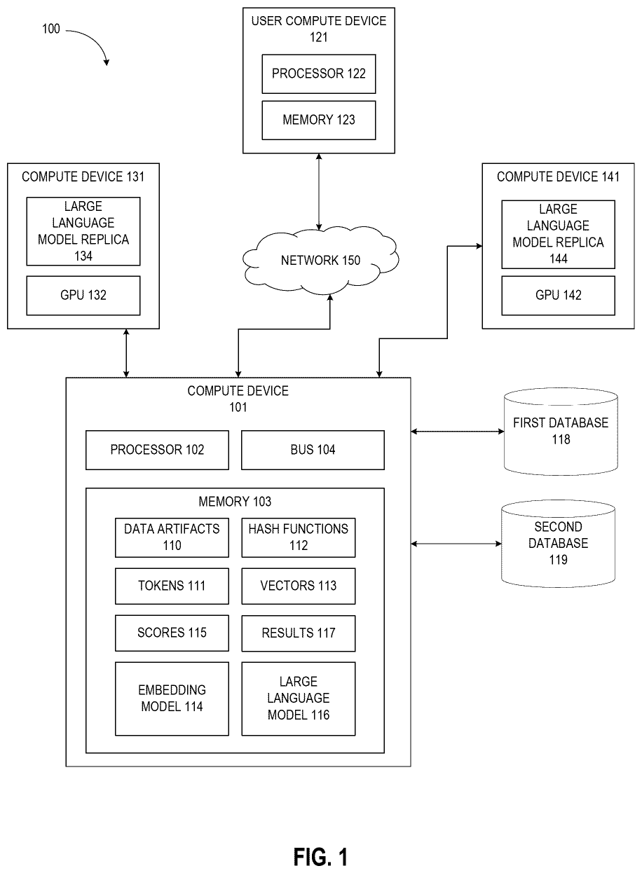

FIG. 1 is a block diagram of a system 100 for retrieval augmented generative AI, according to some embodiments. The system 100 can include a compute device 101 (e.g., AI ingest engine), user compute device 121, compute devices 131, 141, and a network 150. The compute device 101 includes a processor 102 and a memory 103 that communicate with each other, and with other components, via a bus 104. The bus 104 can include any of several types of bus structures including, but not limited to, a memory bus, a memory controller, a peripheral bus, a local bus, and any combinations thereof, using any of a variety of bus architectures. The compute device 101 can be or include, for example, a computer workstation, a terminal computer, a server computer, a handheld device (e.g., a tablet computer, a smartphone, etc.), and/or any machine capable of executing a sequence of instructions that specify an action to be taken by that machine, and any combinations thereof. The compute device 101 can also include multiple compute devices that can be used to implement a specially configured set of instructions for causing one or more of the compute devices to perform any one or more of the aspects and/or methodologies described herein.

The compute device 101 can include a network interface (not shown in FIG. 1). The network interface can be utilized for connecting the compute device 101 to one or more of a variety of networks (e.g., network 150) and one or more remote devices connected thereto. In other words, the various devices including computer device 101, the compute device 131, the compute device 141, and/or the user compute device 121 can communicate with each other via the network 150. The network 150 can include, for example, private network, a Virtual Private Network (VPN), a Multiprotocol Label Switching (MPLS) circuit, the Internet, an intranet, a local area network (LAN), a wide area network (WAN), a metropolitan area network (MAN), a worldwide interoperability for microwave access network (WiMAX®), an optical fiber (or fiber optic)-based network, a Bluetooth® network, a virtual network, and/or any combination thereof. In some instances, the network can be a wireless network such as, for example, a Wi-Fi or wireless local area network (“WLAN”), a wireless wide area network (“WWAN”), and/or a cellular network. In other instances, the network can be a wired network such as, for example, an Ethernet network, a digital subscription line (“DSL”) network, a broadband network, and/or a fiber-optic network. In some instances, the compute device 101 can use Application Programming Interfaces (APIs) and/or data interchange formats (e.g., Representational State Transfer (REST), JavaScript Object Notation (JSON), Extensible Markup Language (XML), Simple Object Access Protocol (SOAP), and/or Java Message Service (JMS)). The communications sent via the network 150 can be encrypted or unencrypted. In some instances, the network 150 can include multiple networks or subnetworks operatively coupled to one another by, for example, network bridges, routers, switches, gateways and/or the like.

The processor 102 can be or include, for example, a hardware based integrated circuit (IC), or any other suitable processing device configured to run and/or execute a set of instructions or code. For example, the processor 102 can be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. In some implementations, the processor 102 can be configured to run any of the methods and/or portions of methods discussed herein.

The memory 103 can be or include, for example, a random-access memory (RAM), a memory buffer, a hard drive, a read-only memory (ROM), an erasable programmable read-only memory (EPROM), and/or the like. In some instances, the memory can store, for example, one or more software programs and/or code that can include instructions to cause the processor 102 to perform one or more processes, functions, and/or the like. In some implementations, the memory 103 can include extendable storage units that can be added and used incrementally. In some implementations, the memory 103 can be a portable memory (e.g., a flash drive, a portable hard disk, and/or the like) that can be operatively coupled to the processor 102. In some instances, the memory 103 can be remotely operatively coupled with a compute device (not shown); for example, a remote database device can serve as a memory and be operatively coupled to the compute device. The memory 103 can include various components (e.g., machine-readable media) including, but not limited to, a random-access memory component, a read only component, and any combinations thereof. In one example, a basic input/output system (BIOS), including basic routines that help to transfer information between components within the compute device 101, such as during start-up, can be stored in memory 103. The memory 103 can further include any number of program modules including, for example, an operating system, one or more application programs, other program modules, program data, and any combinations thereof.

In some implementations, the memory 103 can include and/or store data artifacts 110, tokens 111, hash functions 112, vectors 113, scores 115, results, an embedding model 114, and an LLM 116. The data artifacts 110 can include digital data having a variety of formats (e.g., JPG, PDF, text file, MS Word®, PowerPoint®, Excel®, etc.) that the compute device 101 can ingest. The data artifacts 110 can include artifacts such as, for example, documents, audio files, or other types of data. In some cases, the data artifacts 110 can include files containing ASCII text. The data artifacts 110 can include metadata such as filename, page number, document title if available, and text content to be analyzed. In some implementations, the data artifacts 110 can be ingested by the compute device 101 and covered into a common and/or standard data type (or format) such as, for example, to PDF format. Data artifacts 110 that are converted to PDF format can be used such that images of the PDFs of the data artifacts 110 are available for further retrieval and display to the user by the compute device 101, which can be displayed on the user compute device 121. In some cases, the data artifacts 110 can be provided in a pre-training phase to teach the embedding model 114 to extract, identify, and/or classify information from the data artifacts 110. In some cases, a user operating the user compute device 121 can provide the data artifacts 110 to be ingested by the compute device 101 and used to train the embedding model 114.

In some implementations, the compute device 101 can be configured to check the data artifacts 110 for uniqueness of the data source by computing hash functions of the entire data sources (e.g., data artifacts 110). For instance, the processor 102 can receive another set of data artifacts including, but not limited to, documents and compute hash functions for that set of documents. The processor 102 can check if those hash functions for the new set of documents matches the hash functions 112 for the data artifacts 110. If there is no match, the processor 102 can ingest and store the new set of documents (or documents that have hash functions that do not match). If there are matches, the processor 102 can ignore documents with matching hash functions to avoid storing duplicative data. In some implementations, the data artifacts 110 and the hash functions 112 can be stored in a first database 118. In some cases, the first database 118 can be or include a SQL® database. The first database 118 can be used to store ingested data (e.g., data artifacts 110), encoded documents (e.g., converted PDF documents), and the hash functions 112. For instance, the first database 118 can store file names, hash values, dates and/or timestamps when the files were added, file size, and/or the like.

Once the data artifacts 110 are converted and/or encoded to the standard data type (e.g., PDF), a tokenization process can be performed by the processor 102. In some implementations, tokenization can be required to subdivide natural language identifiers (e.g., text) into “sentence particles” that can be then turned into vectors 113 (or vector representations). The tokenization process can be a function of “chunk size” and “chunk overlap.” For instance, the chunk size can represent a fixed size of paragraphs being extracted from the data artifacts 110 (or encoded documents). The chunk overlap can represent an overlap between paragraphs, for example when a paragraph continues to a next page. In some implementations, a predetermined parameter for chunk size and chunk overlap in the tokenization process to generate the tokens 111. For instance, the tokens 111 can include, for example, 2000 tokens for the chunk size and 200 tokens for overlap. In some cases, the parameters for the chunk size and chunk overlap of the tokens 111 can drive the context size of semantic search and can be used to improve the accuracy of the embedding model 114 in answering queries from the user compute device 121 (or multiple queries from multiple user compute devices).

The vectors 113 (or embeddings) can include transformed text of the data artifacts 110 via the embedding model 114. In some cases, the vectors 113 can include numerical representations of objects, such as words, phrases, or data artifacts 110, in a vector space. In some cases, the vectors 113 can be 1-D vectors. In some implementations, the embedding model 114 can include a vocabulary that maps a word such as “family” to an integer number. Each word in a sentence can then transformed into an integer, creating a string of integer numbers. This string can then be “embedded” into the 1-D vector.

In some implementations, the vectors 113 can be stored in a second database 119. In some cases, the second database 119 can also be referred to as a “vector store database.” In some cases, the second database 119 can only be accessed on a server side (e.g., by the compute device 101). In some cases, the second database 119 can be used to as data repository for embedded text (e.g., vectors 113) to perform semantic searches. The vectors 113 stored in the second database 119 can include, for example, 1-D vector embeddings (e.g., real-value numbers as such 0.3, −0.4, 0.5, etc.).

The embedding model 114 can be trained using the data artifacts 110 (or encoded documents) and configured to generate the vectors 113 In some cases, the embedding model 114 can be assimilated into a small neural network. The embedding model 114 can include a set of model parameters such as weights, biases, or activation functions that can be executed to annotate and/or classify paragraphs the data artifacts 110. The embedding model 114 can be executed during a training phase and/or an inferencing phase.

In the training phase, the embedding model 114 can receive training data and optimizes (or improves) the set of model parameters of the embedding model 114. The set of model parameters are optimized (or improved) such that paragraphs of each document in the data artifacts 110 can be annotated and/or classified correctly with a certain likelihood of correctness (e.g., a pre-set likelihood of correctness).

In some instances, the training data can be divided into batches of data based on a memory size, a memory type, a processor type, and/or the like. In some instances, the data artifacts 110 can be divided into batches of data based on a type of the processor 104 (e.g., CPU, GPU, and/or the like), number of cores of the processor, and/or other characteristic of the memory or the processor.

In some instances, the training data can be divided into a training set, a test set, a validation test, and/or the like. For example, the training data can be randomly divided so that 70% of the training data is in the first training set, 30% of the training data is in the test set, and a separate dataset is used in the validation set to verify model performance and its generalization capabilities on unseen data. The embedding model 114 can be iteratively optimized (or improved) based on the training set while being tested on the first test set to avoid overfitting and/or underfitting of the training set. Once the embedding model 114 is trained based on the training set and the test set, the performance of the embedding model 114 can be further verified based on the validation set.

In the inferencing phase, the embedding model 114 (that is trained in the training phase) can receive at least one document (a document not among the set of documents (e.g., data artifacts 110) used in the training phase) and annotates and/or classifies words and/or paragraphs of the document. Because the inferencing phase is performed using the set model parameters that were already optimized during the training phase, the inferencing phase is computationally efficient.

The embedding model 114 can be used to perform a semantic search by querying the second database 119 of vectors to produce human-readable (and/or comprehensible) text in a user-friendly format in response to queries (e.g., requests, questions, tasks, etc.) by the user operating the user compute device 121. The embedding model 114 can include a set of model parameters such as weights, biases, or activation functions that can be executed to annotate and/or classify vectors 113 stored in the second database 119 to determine relevant information based on queries from the user.

The embedding model 114 can be or include at least one of a deep neural network model (DNN) based on the transformer architecture. In some implementations, the embedding model 114 can be trained to perform a semantic search and produce the results 117 by using a distance function to determine the relevance of retrieved vectors used to generate the results 117 in response to queries from the user. In some cases, the relevance can be translated into a score (or relevance score). The scores 115 can be a numerical value and/or percentage between the ranges of 0 and 100 that represent how relevant a data source that is used for the results 117 in response to a query from the user. In some implementations, the compute device 101 can be implemented with a filtering algorithm. In some cases, the embedding model 114 can be implemented with the filtering algorithm to filter out irrelevant data. For instance, a predetermined threshold can be applied and/or used on the scores 115 to filter out results 117 that do not meet the predetermined threshold. The threshold can be predetermined via user input.

The user compute device 121 can be operated by the user and be structurally similar to the compute device 101. For instance, the user compute device 121 can include a processor 122 and a memory 123 that is structurally similar to the processor 102 and the memory 103, respectively, of the compute device 101. The user compute device 121 can be used to transmit queries to the compute device 101 (via the network 150) to receive results 117 for the queries. In some implementations, the user compute device 121 can include a display that presents to the user a user interface (e.g., AI query interface) to interact with the AI of the compute device 101. In some implementations, the compute device 101 can be configured to perform multiple semantic searches for multiple queries from multiple different user compute devices (not shown in FIG. 1). For instance, the multiple semantic searches can be performed in parallel and/or by different compute devices that run replicas of the large language model 116.

In some implementations, in order to be able to exercise the LLM 116 integrated into a RAG, a compute cluster can be required. Main design feature for the cluster to be considered is a number of GPUs with a certain amount of onboard VRAM. In some implementations, the entire set of weights defining the LLM can be loaded with less than 40 GB of VRAM. Additional VRAM is required for LLMs with a larger parameter footprint. In these steps we assume that we have a cluster composed of N nodes and T GPUs, for a total of N*T GPUs.

In some implementations, the compute device 101 can serve as a head node while compute device 131 and compute device 141 can each serve as a node. Compute device 131 can include a large language model replica 134 of the LLM 116 and a GPU 132. Compute device 141 can include a large language model replica 144 of the LLM 116 and a GPU 142. In some implementations, every node can run one large language model replica per GPU (via an API server). As such, system 100 can be or include an environment for multi-user/multi-node/multi-GPU serving architecture. The compute device 101 can include or be a proxy server (or reverse proxy server) that can perform reverse proxying. This can be a highly efficient parallel architecture based on the reverse proxying technique, where the reverse proxy server dynamically distributes the incoming queries from users to the available compute device or nodes (e.g., compute device 131, compute device 141, etc.). Every GPU on each compute device can run a “replica” of the LLM 116 capable of serving the incoming requests independently.

### Example 1

In some implementations, the system 100 (e.g., RAG AI system) can be used for enterprise deployment. For instance, to recreate the RAG, an LLM can be used and trained on billions of documents. LLMs can be exercised on graphics processing units (GPUs) and the memory requirements are directly proportional to the number of model parameters. A user interface (e.g., AI query interface) can be designed with at least an area to accept user queries and display the AI response. This type of application resembles what is usually defined as a chatbot. Next, a design a role-based access control (RBAC) infrastructure can be designed to control user access to the system as well access to specific collections or datasets. A semantic search algorithm can be implemented which can query a vector database based on the user input. The semantic search can use any distance function to determine the relevance of the retrieved context, however a cosine distance over a normalized vector is preferred since it can be easily translated into a “score” that can be easily interpreted: Rel. Score %=(1.0-CD)*100, where CD stands for cosine distance. The CD indicates “how close” is the user's question to the retrieved text from the data sources. A CD of 0.0 means a perfect match or a relevance of 100%. On the opposite a CD of 1.0 indicates no match or a relevance score of zero.

Next, a filtering algorithm can be implemented to utilize the relevance score to filter out irrelevant data. A simple conditional statement can be used with a pre-defined relevance threshold to achieve this task. Design components in the GUI can be created to control some of the AI settings such as: model temperature, number of relevant sources extracted with semantic search of the queried text, maximum “relevance threshold” to filter out irrelevant information. A query engine using the HTTP POST method can be designed to communicate with the API inferencing server. Standard techniques can be employed to achieve this task. A module can then be designed that utilizes the metadata obtained from the vector store database to extract the document page and create an image that can be rendered on the screen. This approach allows the user to quickly identify the data sources that the AI used in generating the answer. A chat memory feature can be designed by modifying a prompt passed to the AI (e.g., LLM 116) for processing and to be displayed on the user compute device 121. The chat memory can enhance the user's experience by providing a conversational behavior, where the AI can respond to follow up questions in a quasi-human fashion. The prompt to direct the AI can be modified to answer the question by using the user's query, the context found via semantic search, as well as the chat history stored in an array of strings.

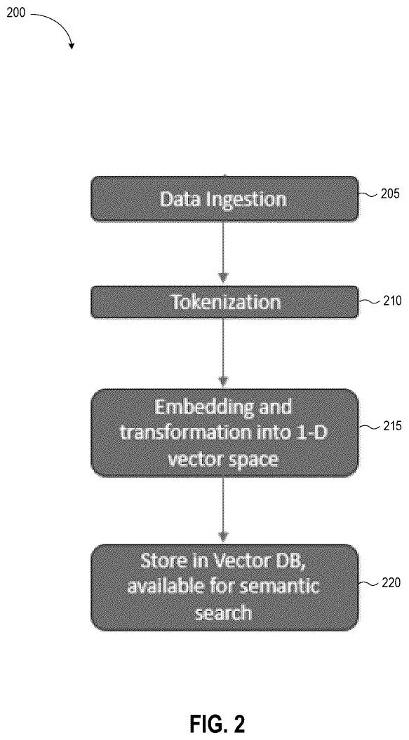

FIG. 2 is an example diagram of a process 200 for data ingestion and tokenization for a RAG AI system, according to some embodiments. The process 200 includes a data ingestion phase 205. At For instance, a compute device (e.g., AI ingest engine or compute device 101 of FIG. 1) of the RAG AI system can receive multiple data. The data source can be a document (PDF, Word, text), an Excel file, or simply a text file containing ASCII text. In some cases, an appropriate document loader needs to be provisioned to be able to open the specific file type and extract: metadata such as filename, page number, document title if available, and most importantly the text content to be analyzed. The compute device can be configured to ingest the data source in any of the formats indicated above, and then to perform a conversion to a standard data type or format (e.g., PDF format). By using this format, the PDF version of the document can be available for further retrieval and display to the user by the AI. In some cases, the data artifacts 110 can be converted to PDF format if they are not already in that format. Results from a semantic search can provide specific page numbers of a PDF version of a document along with an image of that page of the PDF version to be displayed to the user. When adding documents to the knowledge base (e.g., first database 118 of FIG. 1), we also check for uniqueness of the data source by computing a hash function of the entire data source, i.e., document. If the computed hash is already present in the knowledge base the compute device can be configured to inform a user of the duplicative data source and skip data ingestion to avoid duplication of data sources.

The process 200 then includes a tokenization phase 210. Once the documents are converted and/or encoded to the standard data type (e.g., PDF), a tokenization process can be performed by the processor 102. In some implementations, tokenization can be required to subdivide natural language identifiers (e.g., text) into “sentence particles” that can be then turned into a vectors 113 (or vector representations). The tokenization process can be a function of “chunk size” and “chunk overlap.” For instance, the chunk size can represent a fixed size of paragraphs being extracted from the documents (or encoded documents). The chunk overlap can represent an overlap between paragraphs, for example when a paragraph continues to a next page. In some implementations, a predetermined parameter for chunk size and chunk overlap in the tokenization process to generate the tokens. For instance, the tokens can include, for example, 2000 tokens for the chunk size and 200 tokens for overlap. In some cases, the parameters for the chunk size and chunk overlap of the tokens can drive the context size of semantic search and improve the accuracy of an LLM (e.g., LLM 116 of FIG. 1) in answering queries from the user (or multiple queries from multiple users).

The process 200 further includes a phase for embedding and transformation into 1-D vector space 215. Once the data source is tokenized, the compute device can include an embedding model (e.g., embedding model 114 of FIG. 1) to transform the text into a 1-D vector in the real numbers' domain. The embedding model can consist of a vocabulary that maps a word such as “family” to an integer number. Each word in the sentence can then transformed into an integer, creating a string of integer numbers. This string can then be “embedded” into the 1-D vector with the procedure prescribed by the embedding model.

The process 200 further includes a step for store in a vector database available for semantic search 220. The 1-D embedded vectors can then be stored into the vector database (e.g., second database 119 of FIG. 1) The vector database can be served on the server side and searches are performed with a client that connects to the server to perform queries. Other vector databases can be used in this step. The function of the vector database can be to serve as data repository for the embedded text, as well as the engine to perform semantic searches when the AI is queried for information. When storing the 1-D vectors, the compute device can employ normalization and use a cosine distance algorithm when performing a semantic search. Metadata can also be stored in the vector database, representing the file name for the source data, as well as the page number corresponding to the text chunk, now embedded, from the tokenization 210 step. In some cases, additional features implemented for the ingestion phase 205 can include user access control has to be implemented to protect from unauthorized data access, upload/delete functions of files, the user can simply drag and drop one or more files into an AI query interface to trigger the data ingestion phase 205, and/or the like. The vector database (or other databases) can be implemented to track user access privileges. Databases can be implemented with “collection management” to divide topics of interest or to separate sensitive information that can be accessed on a need-to-know basis. Databases can be implemented to add/remove users.

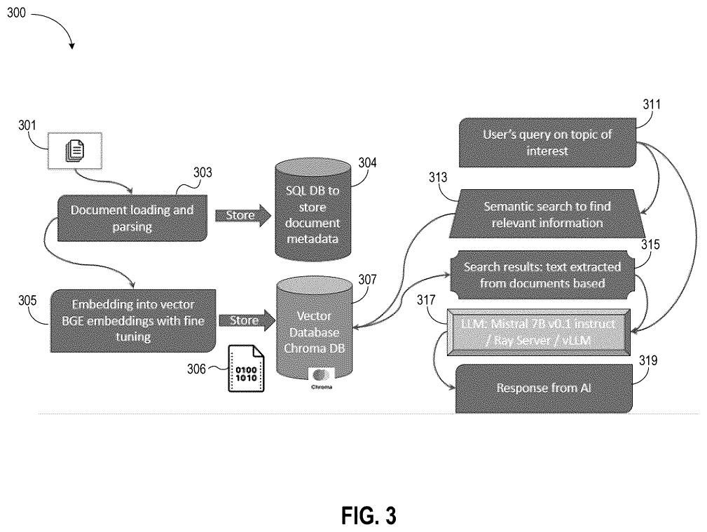

FIG. 3 is an example diagram of a process 300 for data ingestion and AI query, according to some embodiments. At a data ingestion side, and at 303, a compute device (e.g., AI ingest engine or compute device 101 of FIG. 1) can receive a document 301 to be loaded and parsed for storage in a database 304 (e.g., first database 118 of FIG. 1). At 305, the parsed document can be embedded into vectors 306, which can be finetuned. The vector 306 can be stored in a vector database (e.g., second database 119 of FIG. 1).

At a user query side, and at 311, the user can query on a topic of interest. At 313, the compute device can perform a semantic search to find relevant information. In some cases, the compute device can instruct one or more compute device nodes (e.g., compute device 131 and compute device 141 of FIG. 1) to run replicas of an LLM of the compute device to generate, at 319 a response for the user's query. In some implementations, relevant information found from the semantic search at 313 can be stored in the vector database 307. In some implementations, following the semantic search at 313, the compute device can retrieve, at 315, search results from the vector database 307 to be used in instructing the LLM to generate a response for the user's query.

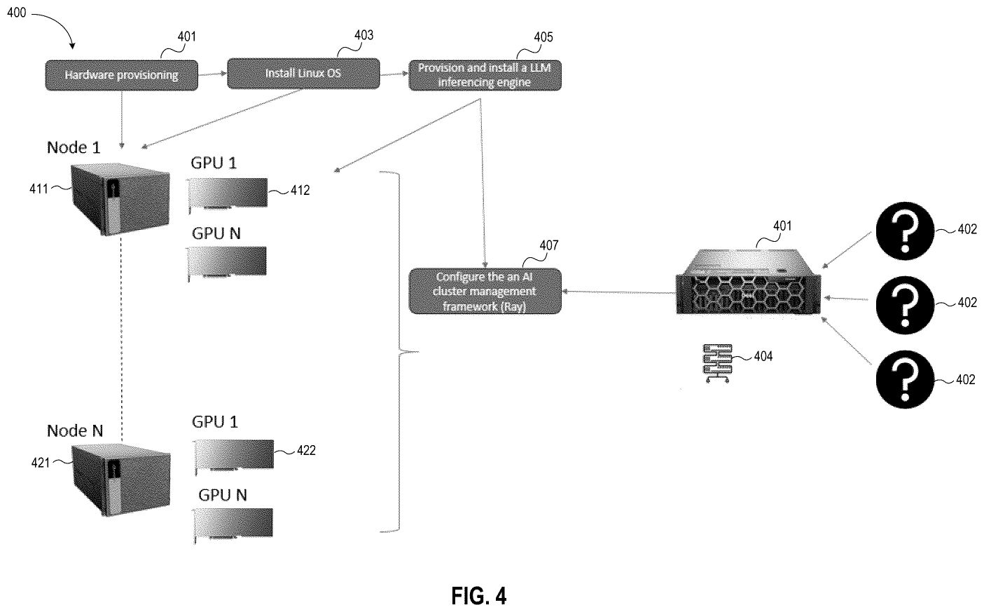

FIG. 4 is an illustrative diagram of a system 400 for deployment of a compute cluster for retrieval augmented generative AI, according to some embodiments. In some implementations, in order to be able to exercise an LLM (e.g., LLM 116) integrated into a RAG, a compute cluster can be required. Main design feature for the cluster to be considered is number of GPUs and amount of onboard VRAM. In our application the LLM can be loaded with less than 40 GB of VRAM. Additional VRAM is required for LLMs with a larger parameter footprint. In these steps we assume that we have a cluster composed of N nodes and T GPUs, for a total of N*T GPUs.

The system 400 can be implemented with a process for deployment of a scalable AI cluster for LLM inferencing. For instance, At 401, hardware provisioning can take place in which the hardware includes N nodes (e.g., node 411, node 421, etc.) and a desired number of GPUs (e.g., GPU 412, GPU 422, etc.) per each node, including storage and network connections. At 403, the process can include installing a suitable operating system (e.g., Linux OS®). At 405, the process can include provisioning and installing a LLM inferencing engine. At 407, the process can include configuring an AI cluster management and provisioning framework in a RAG AI system or a compute device 401 of the RAG AI system. The compute device 401 (e.g., compute device 101 of FIG. 1) can include a reverse proxy server 404 to parallelize incoming user queries 402 for the RAG and for load balancing via the nodes (e.g., node 411, node 421, etc.)

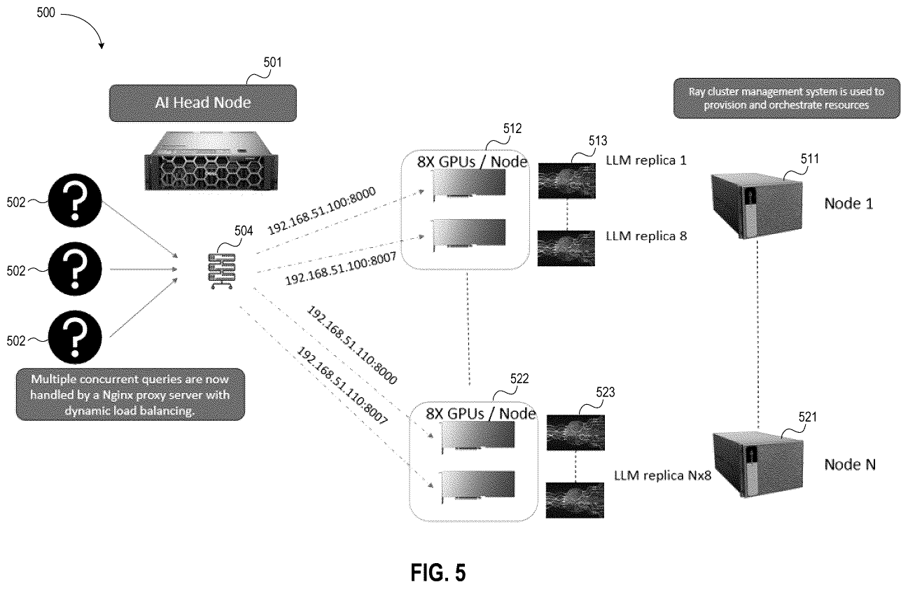

FIG. 5 is an illustrative diagram of a system 500 for reverse proxying in RAG AI, according to some embodiments. Modern inferencing engines, such as LLM, rely on parallel algorithms to accelerate the LLM inferencing process, literally the process involved in asking a question and returning an answer from the AI. Briefly, the parallel algorithms partition the mathematical structures representing the LLM on the available GPUs and perform the inference operations in parallel. This approach can yield a noticeable speed-up in the inferencing process. For example, if the LLM is partitioned on two GPUs, the model can yield an answer in approximately half the time of the case when only one GPU is utilized. The system 500 can be or include a highly-scalable RAG that can serve multiple users concurrently. The RAG AI system can include an AI inferencing engine base on “reverse proxying.”

The system 500 (e.g., cluster management system or RAG AI system) can include an AI head node 501 (e.g., compute device 101 of FIG. 1). The AI head node 501 can be implemented with a proxy server 504 (or reverse proxy server) that can parallelize multiple queries 502 from users via dynamic load balancing. The system 500 can be configured with the AI head node 401 and multiple compute nodes (e.g., compute device 511, compute device 521, etc.) in which the multiple compute device can be joined to the cluster infrastructure of the system 500.

Each node can run an inferencing API (LLM) and instantiate a LLM replica on each GPU made available from the system 500. Effectively, the entire LLM can be loaded on the GPU VRAM since its size allows it, and there are no gains in partitioning the LLM. The AI head node 501 or the reverse proxy server 504 can be specified with a listening port for the API that is not used by another service and can be configured with a number of ports equal to the total number of GPUs used in response to a query from a user. The reverse proxy server 504 can be configured to accept incoming HTTP POST requests. The system 500 can enable the sending of queries via a HTTP POST request to the AI head node 501 running as a reverse proxy. The reverse proxy can distribute the workload on the first available inferencing API running on the GPUs. Experiments have shown that a load balancing strategy for the reverse proxy server 504 can be used for obtaining scalability up to 1000 concurrent queries on a single compute node.

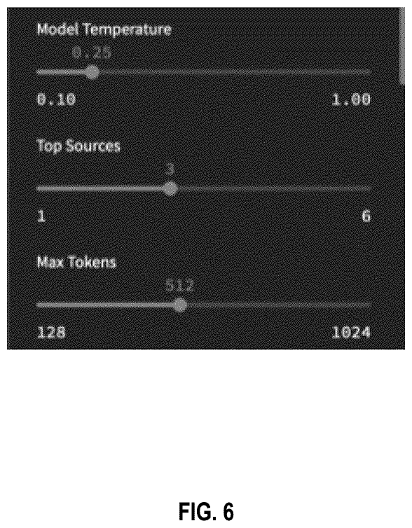

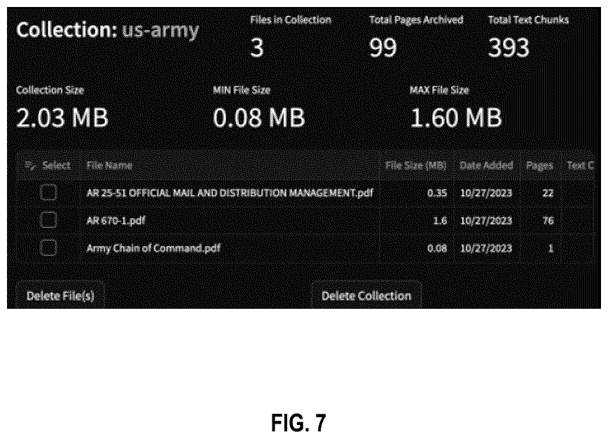

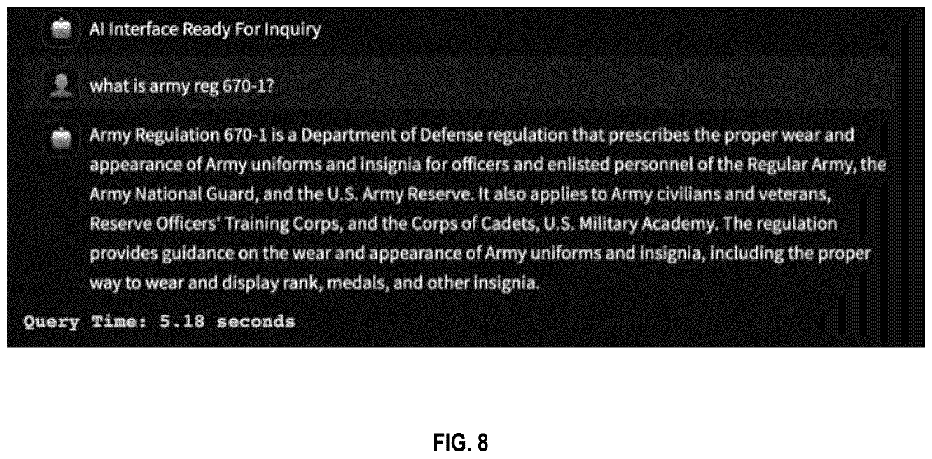

FIG. 6-8 are example screenshots of a user interface for a retrieval augmented generative AI system, according to some embodiments. As shown in FIG. 6, a user can adjust model temperature, max tokens, number of relevant sources extracted with semantic search of the queried text, maximum “relevance threshold” to filter out irrelevant information, and/or the like. As shown in FIG. 7, the user can be presented via the AI query interface data of ingested data including number of files in a collection (e.g., collection of data based on specific topics/categories), file size, collection size, file name, and/or the like. As shown in FIG. 8, a user-friendly chatbot like interaction can be seen that provides answers to user queries.

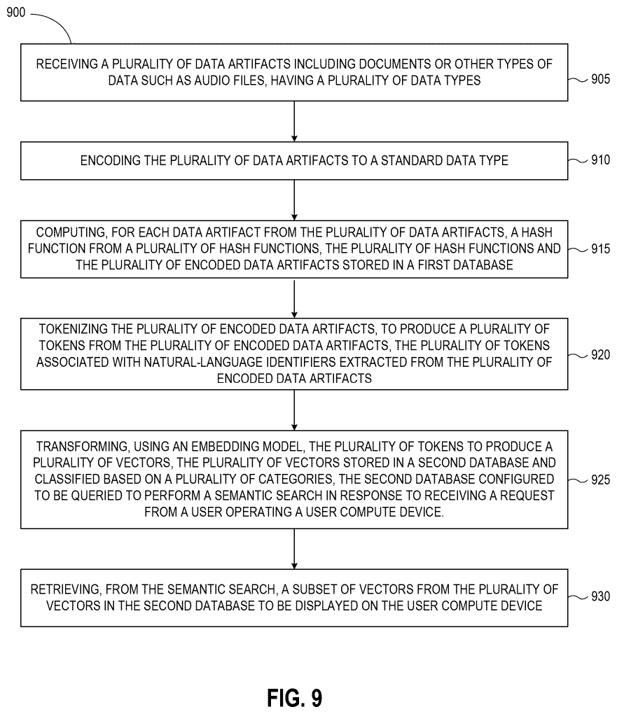

FIG. 9 is a flow diagram of a method 900 for inferencing a large language model for a retrieval augmented generative AI system, according to some embodiments. In some implementations, the method 900 can be performed by a processor of a compute device and/or performed automatically. At 905, the method 900 includes receiving a plurality of data artifacts including documents or other type of data such as audio files, having a plurality of data types.

At 910, the method 900 includes encoding the plurality of data artifacts to a standard data type. In some implementations, the plurality of data artifacts can be encoded automatically.

At 915, the method 900 includes computing, for each data artifact from the plurality of data artifacts, a hash function from a plurality of hash functions, the plurality of hash functions and the plurality of encoded data artifacts stored in a first database. In some implementations, the method 900 can include receiving a second plurality of data artifacts, computing, for each data artifact from the second plurality of data artifacts, a hash function from a second plurality of hash functions, and querying the first database to determine, for each hash function from the plurality of second hash functions, an instance of that hash function in the first database, such that if that hash function is not recorded in the first database, store that hash function and a document associated with that hash function in the first database.

At 920, the method 900 includes tokenizing the plurality of encoded data artifacts, to produce a plurality of tokens from the plurality of encoded data artifacts, the plurality of tokens associated with natural-language identifiers extracted from the plurality of encoded data artifacts. In some implementations, the plurality of tokens can represent a fixed size of a paragraph being extracted from a data artifact from the plurality of data artifacts. In some implementations, the plurality of tokens can represent an overlap between paragraphs in a data artifact from the plurality of data artifacts.

At 925, the method 900 includes transforming, using an embedding model, the plurality of tokens to produce a plurality of vectors, the plurality of vectors stored in a second database and classified based on a plurality of categories, the second database configured to be queried to perform a semantic search in response to receiving a request from a user operating a user compute device. In some implementations, the embedding model can be consistent with the embedding model 114 of FIG. 1 one described herein.

The retrieved information (e.g., vectors) can be stored into the second database and made available to perform semantic searches when the RAG AI system is queried by the user. In some instances, text chunks from data artifacts (e.g., documents) can be extracted and tokenized to produce the plurality of tokens. The plurality of tokens can then be transformed into vector embeddings based on the embedding model.

In some cases, the embedding model can be fine-tuned outside of the RAG AI system. Default embedding models can be fine-tuned to better represent a specific topic. For example, the United States Army has its own jargon as well as other government agencies. The default embedding models have been trained on a vast but generic corpus of data. To improve the accuracy of the semantic search performed on the embedded data artifacts, the embedding model can be fine-tuned as follows. For instance, select a representative corpus of data for the topic of interest, such as manuals, procedures. Then, generate a question/answer dataset by using an LLM to ask questions and formulate answers. This dataset can be created by prompting the LLM to process the data artifacts and literally formulate questions and provide answers to itself, including the data artifact reference. Then, split the data into training/testing sets. Then, use the training and testing datasets to re-train the neural networks that make up the embedding model. Then, measure the performance of the fine-tuned embedding model versus the default model using recall, precision, and F1 metrics.

At 930, the method 900 includes retrieving, from the semantic search, a subset of vectors from the plurality of vectors in the second database to be displayed on the user compute device. The subset of vectors can be the results for the query by the user. In some implementations, an LLM can be used to produce conversational text to be displayed on the user compute device along with the subset of vectors (e.g., results) to mimic conversational speech with the user.

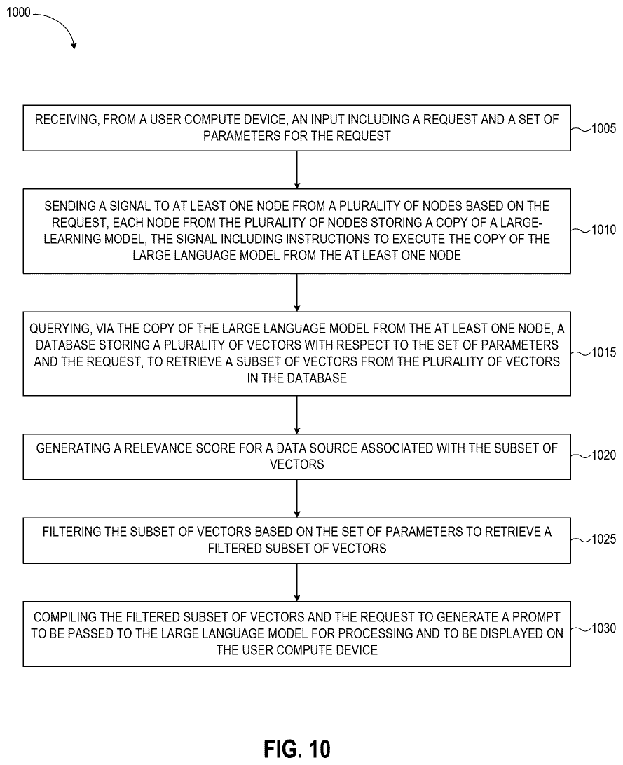

FIG. 10 is a flow diagram of a method 100 for executing one or more large language models for a retrieval augmented generative AI system, according to some embodiments. The method 100 can be performed by a processor of a compute device and/or performed automatically. At 1005, the method 1000 includes receiving, from a user compute device, an input including a request and a set of parameters for the request. The request can be or include a query from the user.

At 1010, the method 1000 includes sending a signal to at least one node from a plurality of nodes based on the request, each node from the plurality of nodes storing a copy of a large language model, to signal including instructions to execute the copy of the large language model from the at least one node. This is so, at least in part to enable parallelization in a multi-user/multi-node/multi-GPU serving architecture and based on a proxying technique that includes dynamically distributing the incoming queries, i.e., users, to available compute nodes. Every GPU on each compute node can run a “replica” of the large language model capable of serving the incoming requests independently.

At 1015, the method 1000 includes querying, via the copy of the large language model from the at least one node, a database storing a plurality of vectors with respect to the set of parameters and the request, to retrieve a subset of vectors from the plurality of vectors in the database. The subset of vectors can represent an answer or response to a query from the user.

At 1020, the method 1000 includes generating a relevance score for a data source associated with the subset of vectors. In some cases, the method 1000 can include generating a relevance score from a plurality of relevance scores for each data source from a plurality of data sources associated with the subset of vectors retrieved from the database.

At 1025, the method 1000 includes filtering the subset of vectors based on the set of parameters to retrieve a filtered subset of vectors. In some cases, the filtered subset of vectors can be or include the results from a semantic search in response to the query from the user.

At 1030, the method includes compiling the filtered subset of vectors and the request to generate a prompt to be passed to the large language model for processing and to be displayed on the user compute device. For instance, the filtered vectors (also referred to as context) can be passed together with the user query and chat memory to the large language model in the form of a prompt that can be designed to mimic conversational speech with a user. In some cases, the prompt can be how the AI is “programmed” or instructed to accurately answer questions or solve problems for the topic in question. A typical prompt can be as follows: “You are a very capable AI and an expert in fluid dynamics. Answer the following question, using the context provided and take into account the conversational memory included. If you do not know the answer, please state that.” In other words, the prompt can follow: PROMPT=System Prompt+User Query+Context+Memory. The PROMPT can then be passed to the LLM and the answer can be generated and displayed to the user on the user compute device. In some implementations, the method 1000 can include extracting an image of the data source associated with the filtered subset of vectors to be displayed on the display of the user compute device.

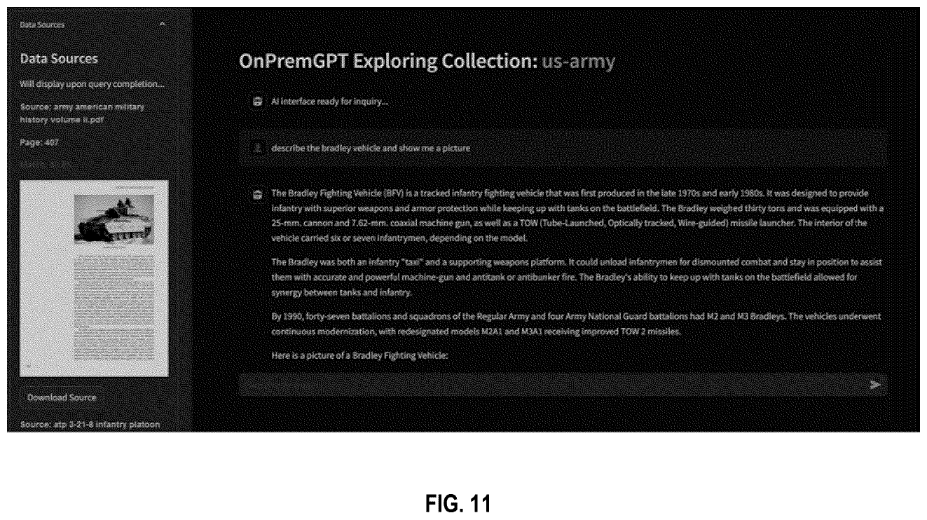

FIG. 11 is an example screenshot illustrating a return of a query from a request by a user including an image of a source document associated with the return, according to some embodiments. As shown in FIG. 11, the AI can produce, via an LLM, a response to the user in a friendly and/or conversational manner that is comprehensible to the user. The AI can also display an image of a source document that was used to generate the response to the query from the request by the user.

While there has been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

### Definitions

The instant invention is most clearly understood with reference to the following definitions.

All definitions, as defined and used herein, should be understood to control over dictionary definitions, definitions in documents incorporated by reference, and/or ordinary meanings of the defined terms.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Less specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

The term “automatically” is used herein to modify actions that occur without direct input or prompting by an external source such as a user. Automatically occurring actions can occur periodically, sporadically, in response to a detected event (e.g., a user logging in), or according to a predetermined schedule.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general-purpose processor, a central processing unit (CPU), a microprocessor, a digital signal processor (DSP), a controller, a microcontroller, a state machine and so forth. Under some circumstances, a “processor” can refer to an application specific integrated circuit (ASIC), a programmable logic device (PLD), a field programmable gate array (FPGA), etc. The term “processor” can refer to a combination of processing devices, e.g., a combination of a DSP and a microprocessor, multiple microprocessors, one or more microprocessors in conjunction with a DSP core or any other such configuration.

The term “memory” should be interpreted broadly to encompass any electronic component capable of storing electronic information. The term memory can refer to various types of processor-readable media such as random-access memory (RAM), read-only memory (ROM), non-volatile random-access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” can refer to one or more programs, routines, sub-routines, functions, procedures, etc. “Instructions” and “code” can comprise a single computer-readable statement or many computer-readable statements.

The term “modules” can be, for example, distinct but interrelated units from which a program may be built up or into which a complex activity may be analyzed. A module can also be an extension to a main program dedicated to a specific function. A module can also be code that is added in as a whole or is designed for easy reusability.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per sc (e.g., a propagating electromagnetic wave carrying information on a transmission medium such as space or a cable). The media and computer code (also can be referred to as code) can be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules can include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed.

Various concepts can be embodied as one or more methods, of which at least one example has been provided. The acts performed as part of the method can be ordered in any suitable way. Accordingly, embodiments can be constructed in which acts are performed in an order different than illustrated, which can include performing some acts simultaneously, even though shown as sequential acts in illustrative embodiments. Put differently, it is to be understood that such features can not necessarily be limited to a particular order of execution, but rather, any number of threads, processes, services, servers, and/or the like that can execute serially, asynchronously, concurrently, in parallel, simultaneously, synchronously, and/or the like in a manner consistent with the disclosure. As such, some of these features can be mutually contradictory, in that they cannot be simultaneously present in a single embodiment. Similarly, some features are applicable to one aspect of the innovations, and inapplicable to others.

In addition, the disclosure can include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein can be implemented in a manner that enables a great deal of flexibility and customization as described herein.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A non-transitory, processor-readable medium storing instructions that when executed by a processor, cause the processor to:
receive a plurality of data artifacts including documents or other type of data such as audio files, having a plurality of data types;
encode the plurality of data artifacts to a standard data type;
compute, for each data artifact from the plurality of data artifacts, a hash function from a plurality of hash functions, the plurality of hash functions and the plurality of encoded data artifacts stored in a first database;
tokenize the plurality of encoded data artifacts, to produce a plurality of tokens from the plurality of encoded data artifacts, the plurality of tokens associated with natural-language identifiers extracted from the plurality of encoded data artifacts;
transform, using an embedding model, the plurality of tokens to produce a plurality of vectors, the plurality of vectors stored in a second database and classified based on a plurality of categories, the second database configured to be queried to perform a semantic search in response to receiving a request from a user operating a user compute device; and
retrieve, from the semantic search, a subset of vectors from the plurality of vectors in the second database to be displayed on the user compute device.

2. The non-transitory, processor-readable medium of claim 1, wherein:
the plurality of data artifacts is a first plurality of data artifacts,
the plurality of hash functions is a first plurality of hash functions, and
the processor is further caused to:
receive a second plurality of data artifacts;
compute, for each data artifact from the second plurality of data artifacts, a hash function from a second plurality of hash functions; and
query the first database to determine, for each hash function from the plurality of second hash functions, an instance of that hash function in the first database, such that if that hash function is not recorded in the first database, store that hash function and a data artifact associated with that hash function in the first database.

3. The non-transitory, processor-readable medium of claim 1, wherein the plurality of tokens represents a fixed size of a paragraph being extracted from a data artifact from the plurality of data artifacts.

4. The non-transitory, processor-readable medium of claim 1, wherein the plurality of tokens represents an overlap between paragraphs in a data artifact from the plurality of data artifacts.

5. The non-transitory, processor-readable medium of claim 1, wherein a vector from the plurality of vectors includes a 1-D vector that represents a string of integer numbers.

6. The non-transitory, processor-readable medium of claim 1, wherein the second database is not accessible to external devices.

7. The non-transitory, processor-readable medium of claim 1, wherein the plurality of data artifacts is encoded automatically.

8. An apparatus comprising:
a processor; and
a memory operatively coupled to the processor, the memory storing instructions to cause the processor to:
receive, from a user compute device, an input including a request and a set of parameters for the request;
send a signal to at least one node from a plurality of nodes based on the request, each node from the plurality of nodes storing a copy of a large language model, the signal including instructions to execute the copy of the large language model from the at least one node;
query, via the copy of the large language model from the at least one node, a database storing a plurality of vectors with respect to the set of parameters and the request, to retrieve a subset of vectors from the plurality of vectors in the database;
generate a relevance score for a data source associated with the subset of vectors;
filter the subset of vectors based on the set of parameters to retrieve a filtered subset of vectors; and
compile the filtered subset of vectors and the request to generate a prompt to be passed to the large language model for processing and to be displayed on the user compute device.

9. The apparatus of claim 8, wherein the memory stores instructions to further cause the processor to extract an image of the data source associated with the filtered subset of vectors to be displayed on the display of the user compute device.

10. The apparatus of claim 8, wherein the memory stores instructions to cause the processor to generate a relevance score from a plurality of relevance scores for each data source from a plurality of data sources associated with the subset of vectors retrieved from the database.

11. The apparatus of claim 8, wherein the memory stores instructions to cause the processor to execute a reverse proxying technique to control multiple replicas of the large learning model in order to achieve high-throughput and scalability for a large number of concurrent queries or users.
